(19) United States
(12) Patent Application Publication
(10) Pub. No.: US 2024/0407358 A1
(43) Pub. Date: Dec. 12, 2024

(54) CELLULOSE NANOCRYSTAL STABILIZED CHEMICAL COMPOSITION

(71) Applicant: SYNGENTA CROP PROTECTION AG, Basel (CH)

(72) Inventors: Lewis Charles WILKINS, Greensboro, NC (US); Andrew James COUGHLIN, Greensboro, NC (US); Martine Ingrid DE HEER, Bracknell (GB)

(73) Assignee: SYNGENTA CROP PROTECTION AG, Basel (CH)

(21) Appl. No.: 18/700,749

(22) PCT Filed: Oct. 10, 2022
(86) PCT No.: PCT/EP2022/078028

§ 371 Date: Apr. 12, 2024

Related U.S. Application Data
(60) Provisional application No. 63/262,525, filed on Oct. 14, 2021.

(51) Int. Cl. A01N 25/04; A01N 53/00; A01P 7/04

(52) U.S. Cl. CPC A01N 25/04; A01N 53/00; A01P 7/04

(57) ABSTRACT

Liquid compositions having a first phase, a second phase which is immiscible and dispersed in the first phase, a matrix of cross-linked cellulose nanocrystals at the interface between the first phase and the second phase, and at least one agrochemically active ingredient in the second phase, as well as methods of use and making thereof.

### CROSS-REFERENCE TO RELATED APPLICATIONS

This application claims the benefit of U.S. provisional application Ser. No. 63/262,525, filed Oct. 14, 2021, the entire contents of which are incorporated by reference herein.

### TECHNICAL FIELD

The present invention relates to stabilized, liquid, chemical compositions, the preparation of such compositions and a method of using such compositions, for example, to combat pests or as plant growth regulators.

### BACKGROUND OF THE INVENTION

In general, current encapsulation technology for agrochemicals relies on the formation of polyurea walls from the condensation reaction of isocyanate monomer building blocks. These formulations result in the release of microplastics which are not particularly biodegradable and may persist in the environment for years. Accordingly, there is a need for biodegradable alternatives.

### SUMMARY OF THE INVENTION

These and other problems are solved using cellulose nanocrystals (“CNCs”) in agrochemical formulations.

The invention includes a liquid composition, having a first phase, a second phase which is immiscible and dispersed in the first phase, a matrix of cross-linked cellulose nanocrystals at the interface between the first phase and the second phase, and at least one agrochemically active ingredient in the second phase.

The invention includes a method which involves preparing a first phase, preparing a second phase, dissolving or suspending an agrochemical active ingredient into the second phase, incorporating cellulose nanocrystals in one or both of the first phase or the second phase, combining the first phase and the second phase to form a composition, agitating the composition to form an emulsion; and cross-linking the cellulose nanocrystals to form a matrix shell around droplets of the second phase.

The invention includes an article of manufacture having a plant seed coated with a first phase, a second phase which is immiscible and dispersed in the first phase, a matrix of cross-linked cellulose nanocrystals at the interface between the first phase and the second phase, and at least one agrochemically active ingredient in the second phase.

### BRIEF DESCRIPTION OF THE DRAWINGS

FIG. 1 is an image of crosslinked and non-crosslinked CNC formulations after two-weeks of cycling temperature.

FIG. 2 is microscopy imaging of crosslinked and non-crosslinked CNC formulations after drying.

FIG. 3 is a graph of the release rate of dimethylphthalate from crosslinked and non-crosslinked CNC formulations.

FIG. 4 is a graph of lambda-cyhalothrin release rate profiles.

FIG. 5 is a graph of further lambda-cyhalothrin release rate profiles.

FIG. 6 is a graph of lambda-cyhalothrin release rate profiles after two-weeks of storage at 25° C. or 54° C.

### DETAILED DESCRIPTION OF THE INVENTION

Embodiments of the present invention utilize CNCs to stabilize and/or encapsulate agrochemicals in formulations. CNCs have been used in Pickering emulsions as colloidal particles to stabilize the oil-water interface. See U.S. Pat. No. 9,260,551 incorporated by reference herein.

CNCs are particularly unique in the field of emulsion stabilization due to their amphiphilic nature resulting from their long-range crystalline structure. This structure allows hydrophilic hydroxyl groups on one face and hydrophobic alkyl groups on the juxtaposed face. This feature allows CNCs to wet an interfacial region between aqueous and non-aqueous media resulting in a Pickering stabilized emulsion system.

Additionally, CNC's relatively high aspect ratio, presenting as needle or rod-like structures, are also beneficial to emulsion stability. Cellulosic materials are used as benchmarks for microbial biodegradation studies thus, their utilization as Pickering stabilizers offer a plethora of benefits in terms of physical stability and encapsulation of agriculturally active ingredients, all while offering an interfacial matrix that is environmentally benign and which should readily biodegrade in soil.

In the present invention, the source and/or polymorph of CNC is not limited. Embodiments of the invention can use any CNCs, whether artificially or naturally occurring. Furthermore, CNCs can be derived from naturally occurring biomaterials such as hard and soft wood pulp, non-wood residues, tunicate and bacteria, and other sources. The raw materials can be broken down from the macrostructures to individual fibrils and eventually the crystalline cellulose domains using a combination of established mechanical and chemical treatments.

In general, CNCs will have a needle-like or elongated shape. These elongated or needle like shapes can be understood in two dimensions as having a length and width. With respect to needle-like shapes, the width refers to the maximum width of the needle. In certain embodiments CNCs have a width of 1-50 nm. In preferred embodiments, the width is 4-25 nm. Accordingly, it follows the width can be about any one of 1, 2, 3, 4, 5, 6, 7, 8, 9, 10, 11, 12, 13, 14, 15, 16, 17, 18, 19, 20, 21, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 nm, or any range utilizing these widths. In other embodiments, CNCs can have a length of 50-1000 nm. In preferred embodiments, the length is 100-400 nm. It follows the length can be about any one of 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000 nm, or any range utilizing these lengths, or in between such lengths.

In some embodiments, the CNCs can be defined in terms of dimensions, i.e., aspect ratios. The aspect ratio is defined as ratio between the width to the length. CNCs can have an aspect ratio of 1:2-1:200. In preferred embodiments, the aspect ratio is 1:20-1:80. It follows the width can be about any one of 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, and 1:50 or any range utilizing these aspect ratios.

The size and dimensions of CNCs used in formulation can be in the form of a gaussian distribution. In specific embodiments the CNCs can have a multimodal distribution. Multimodal distributions include bimodal, trimodal, or higher. The standard deviation can vary depending on the specific parameter, for example, the standard deviation for the width can be 0.1, 1, 2, 3, 5, or 10 nm, or a range in between. Alternatively, the standard deviation for the length can be 1, 5, 10, 25, 50, 100, 250, or 500 nm, or a range in between. In some embodiments, the standard deviation for the length of the aspect ratio can be ±1, ±2, +3, +5, +10, or +20, or a range in between.

Depending on the embodiment, the CNCs are about 0.1-3% w/w of the total composition. In preferred embodiments, the CNCs are 0.5-1.5% w/w. It follows that the total amount of CNCs in the composition can be about any one of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0, or a range in between. In some embodiments, the CNCs may be include in excess. In these embodiments, the total amount of CNCs can be at least about 3%, 4%, 5%, 6%, 7%, 8%, 9%, or 10% w/w.

In a specific embodiment, the formulation provides a liquid composition including a first phase, a second phase which is immiscible and dispersed in the first phase, a matrix of cross-linked cellulose nanocrystals at the interface between the first phase and the second phase, and at least one agrochemically active ingredient in the second phase.

In some embodiments, the first phase can be selected so the agrochemically active ingredient is distributed solely, or substantially solely, in the second phase. In such embodiments, none or substantially none of the agrochemically active ingredient migrates to the first phase. Those skilled in the art will readily be able to determine whether a particular aqueous liquid meets this criterion for a specific agrochemically active ingredient in question by following any standard test procedure for determining the partition coefficient of a compound between the first phase and the second phase.

In a further embodiment, the first phase is an aqueous liquid or a solution of water-soluble solutes in water.

Water-soluble solutes suitable for use in the first phase include salts such as halides, nitrates, sulfates, carbonates, phosphates, nitrites, sulfites, nitrides and sulfides of ammonium and of metals such as those of groups 1 to 12 of the periodic table. Other suitable solutes include sugars and osmolytes such as polysaccharides, proteins, betaines and amino acids.

In one embodiment, the aqueous liquids suitable for use in the first phase are mixtures of water and a substantially water-miscible non-aqueous liquid. In the context of the invention, the term “substantially water-miscible” means a non-aqueous liquid that forms a single phase when present in water at a concentration up to at least 50 wt %.

Substantially water-miscible non-aqueous liquids suitable for use in the first phase include, for example, propylene carbonate; a water-miscible glycol selected from ethylene glycol, diethylene glycol, triethylene glycol, propylene glycol, dipropylene glycol, tripropylene glycol, butylene glycol, hexylene glycol and polyethylene glycols having a molecular weight of up to about 800; an acetylated glycol such as di(propylene glycol) methyl ether acetate or propylene glycol diacetate; triethyl phosphate; ethyl lactate; gamma-butyrolactone; a water-miscible alcohol such as propanol or tetrahydrofurfuryl alcohol; N-methyl pyrrolidone; dimethyl lactamide; and mixtures thereof. In one embodiment, the non-aqueous, substantially water-miscible liquid used in the first phase is a solvent for at least one optional agrochemically active ingredient.

In another embodiment, the aqueous, substantially water-miscible liquid used in the first phase is fully miscible with water in all proportions. Alternatively, the aqueous, substantially water-miscible liquid used in the first phase is a waxy solid such as polyethylene glycol having a molecular weight above about 1000 and the mixture of this waxy solid with water is maintained in the liquid state by forming the composition at an elevated temperature.

In another embodiment, the second phase is a non-aqueous liquid. In another embodiment, the first phase is a substantially water-immiscible, non-aqueous liquid. The water-immiscible, non-aqueous liquid may be selected from petroleum distillates, vegetable oils, silicone oils, methylated vegetable oils, refined paraffinic hydrocarbons, alkyl lactates, mineral oils, alkyl amides, alkyl acetates, and mixtures thereof.

In another embodiment, the first phase comprises a substantially water-miscible, non-aqueous liquid. The water-miscible, non-aqueous liquid may be selected from the group comprising propylene carbonate, ethylene glycol, diethylene glycol, triethylene glycol, propylene glycol, dipropylene glycol, tripropylene glycol, butylene glycol, hexylene glycol, polyethylene glycols having a molecular weight of up to about 800, di(propylene glycol) methyl ether acetate, propylene glycol diacetate, triethyl phosphate, ethyl lactate, gamma-butyrolactone, propanol, tetrahydrofurfuryl alcohol, N-methyl pyrrolidone, dimethyl lactamide, and mixtures thereof.

Those skilled in the art will appreciate that the quantities of water and the nature and quantity of the non-aqueous, water-miscible liquid or water-soluble solute can be varied to provide mixed aqueous liquids suitable for use in the first phase and these quantities can be determined without undue experimentation.

The second phase is selected to be immiscible in the first phase. The second phase can be selected based on the first phase, or the first phase can be selected based on the second phase. In addition, both the first and second phase can be selected based on the physical properties of the selected agrochemically active ingredient such that appropriate suspension or solvation is achieved.

In preferred embodiments, the second phase is a non-aqueous solvent or oil such as, but not limited to, alkylated aromatic carboxylic acids (acetophenone, benzyl benzoate, butyl benzoate); tris(2-ethylhexyl)phosphate; fatty acid oils (stearic acid, linoleic acid, oleic acid, canola oil, rapeseed oil, soybean oil); alkylated fatty acid oils (e.g. methylated rapeseed oil, methyl oleate, methylated soybean oil); aromatic hydrocarbons; cyclohexane-1,2-dicarboxylic acid diisononyl ester; petroleum distillates (including mineral oils); alkylated pyrollidones; simple chain alkanes (e.g. heptane, dodecane, hexadecane and isomers thereof); and fatty alcohols (octanol, stearyl alcohol, oleyl alcohol).

Depending on the embodiment, the first phase may comprise 50 to 90% w/w of the composition while the second phase may comprise 10-50% w/w of the composition. In certain embodiments, the second phase is any one of about 10%, 12%, 14%, 16%, 18%, 20%, 22%, 24%, 26%, 28%, 30%, 32%, 34%, 36%, 38%, 40%, 42%, 44%, 46%, 48%, and 50%, or amounts and ranges in between.

In general, the matrix of crosslinked CNCs at the interface between the first phase and the second phase is formed by dispersing CNCs in one of the first phase or the second phase, combining the first and the second phase, mixing and/or agitating the first phase and the second phase such that the second phase is dispersed in the first phase, and then crosslinking the CNCs.

In certain embodiments, salts can be used to modulate the surface charge density on the surface of the CNC as necessary to ensure maximum coverage of the CNCs over the surface of the droplet. Specific salts include, but are not limited to, mono and poly-valent metal halides such as NaCl or CaCl₂ or organic salt derivatives such as (NH₄)₂SO₄. The concentration of the salt can be 0.001 to 0.1 M. These salts may be present prior to crosslinking or in the final composition. In certain embodiments, the amount of salt is 0.001, 0.005, 0.01, 0.05 or 0.1, or amounts and ranges in between.

Surfactants may further be included to aid in the particle size uniformity and stability. The surfactant may be chosen based on the particular first phase and second phase or actives contained within. In general, the surfactant may be about 0.01 to 5% w/w. In specific embodiments, the surfactant is sodium dodecylsulfate. Specific embodiments are directed to formulations without a solvent.

Certain embodiments of the invention are directed to compositions where the interface between first phase and the second phase is 30-100% covered by CNCs. 100% coverage corresponds to solid matrices. In specific embodiments, the interface is at least 60% covered by CNCs. In other embodiments, the interface is 50-80% covered in CNCs. The CNCs may cover about 30%, 35%, 40%, 45%, 50%, 55%, 60%, 65%, 70%, 75%, 80%, 85%, 90%, 95%, or 100%, or amounts and ranges in between.

The CNCs may be crosslinked using any technique known in the art. Preferred methods of cross-linking include chemical and physical cross-linking with polyaldehydes, polyphenols, polyamines or polycarboxylic acids. Specific crosslinkers include glutaraldehyde, citric acid, tannic acid and boric acid. Preferred crosslinkers include glutaraldehyde and citric acid.

Other methods to crosslink may occur by exploiting ionic interactions between CNC particles using various poly-valent metals and their corresponding salts with general examples including, but not limited to, salts of Mg(II), Ca(II), Fe(III), Cu(II), Zn(II) or Al(III).

The amount of crosslinker used can depend on the specific crosslinker. In general the amount of crosslinker can be more than 0.01% w/w, in some embodiments the crosslinker is present in from 0.01 to 10% w/w. In preferred embodiments, the crosslinker is present in 0.01 to 5% w/w. In some embodiments, the amount of crosslinker is 0.01% 0.02%, 0.05%, 0.1%, 0.2%, 0.5%, 0.7%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10% w/w, or amounts and ranges in between.

In specific embodiments, the second phase comprises droplets with a diameter between 1 and 100 microns. In preferred embodiments, the droplet size is 1 to 30 microns. The diameter may be defined by the mean diameter size. It follows that the diameter can be 1, 1.5, 2, 2.5, or 3 microns, or amounts and ranges in between. In specific embodiments, the diameter is less than 10 microns, less than 5 microns, less than 3 microns, less than 2 microns, less than 1 micron, or less than 0.5 microns.

In some embodiments, the formulation and droplets can be defined by their properties. For instance, the release rate of agrochemical or storage stability.

In some embodiments, the release rate is defined as the rate at which the agriculturally active ingredient diffuses across the interfacial matrix to the surrounding medium, for instance into the soil or leaf surface or a solvent reservoir. For the purposes of quantification, release rate tests may be performed to compare the rate at which the active ingredient diffuses across the interfacial matrix with other formulations. Without being bound by theory, modifications such as crosslinking may modulate the release rate resulting in either delayed or fast release capsules based on percent release as a function of time. Both fast and slow release capsules are advantageous to agricultural pesticide products and are targeted using this technology. In some embodiments, maximum release of the agriculturally active ingredient payload is achieved within 1, 2, 3, 4, 5, 6, 12, or 24 hours of application. In other embodiments, maximum release of the agriculturally active ingredient payload is achieved within 1, 2, 3, 4, 5, 6, 7, 8, 9 or 10 days of application.

In some embodiments, storage stability is defined as the ability of the formulated product to remain physically and chemically stable over the course of a minimum 2 year shelf life. This may be achieved through prolonged storage at low, ambient or high temperatures as well as temperature cycling procedures to simulate the ageing process. Physical stability refers to the ability of the formulation to resist emulsion failure through coalescence, Ostwald ripening, flocculation, creaming, phase separation or other physical changes such as thickening or sedimentation. Additionally, chemical stability is defined as the ability of the formulated product to withstand chemical degradation of the agriculturally active ingredients contained within the formulation. Typically, acceptable active ingredient decomposition tolerances are ±10% for 0-1 wt % loading, +5% for 1-20 wt % loading and +3% for loadings greater than 20 wt % over the course of these simulated storage conditions.

The term “agrochemically active ingredient” refers to chemicals and biological compositions, such as those described herein, which are effective in killing, preventing, or controlling the growth of undesirable pests, such as, plants, insects, mice, microorganism, algae, fungi, bacteria, and the like (such as pesticidally active ingredients). The term may also apply to compounds that act as adjuvants to promote the uptake and delivery of other active compounds. The term may also apply to compounds that control the growth of plants in a desired fashion (e.g., plant growth regulators), to a compound which mimics the natural systemic activated resistance response found in plant species (e.g., plant activator) or to a compound that reduces the phytotoxic response to a herbicide (e.g., safener). If more than one is present, the agrochemically active ingredients are independently present in an amount that is biologically effective when the composition is diluted, if necessary, in a suitable volume of liquid carrier, e.g., water, and applied to the intended target, e.g., the foliage of a plant or locus thereof.

The following, in addition to their enantiomers, are examples of agrochemical active ingredients suitable for use, but are not limited to: fungicides such as azoxystrobin, benzovindiflupyr, chlorothalonil, cyproconazole, cyprodinil, difenoconazole, fenpropidin, fludioxonil, mandipropamid, mefenoxam, paclobutrazole, picoxystrobin, propiconazole, pyraclostrobin, sedaxane, tebuconazole, thiabendazole and trifloxystrobin; herbicides such as acetochlor, alachlor, ametryn, anilofos, atrazine, azafenidin, benfluralin, benfuresate, bensulide, benzfendizone, benzofenap, bicyclopyrone, bromobutide, bromofenoxim, bromoxynil, butachlor, butafenacil, butamifos, butralin, butylate, cafenstrole, carbetamide, chloridazon, chlorpropham, chlorthal-dimethyl, chlorthiamid, cinidon-ethyl, cinmethylin, clomazone, clomeprop, cloransulam-methyl, cyanazine, cycloate, desmedipham, desmetryn, dichlobenil, diflufenican, dimepiperate, dimethachlor, dimethametryn, dimethenamid, dimethenamid-P, dinitramine, dinoterb, diphenamid, dithiopyr, EPTC, esprocarb, ethalfluralin, ethofumesate, etobenzanid, fenoxaprop-ethyl, fenoxaprop-P-ethyl, fentrazamide, flamprop-methyl, flamprop-M-isopropyl, fluazolate, fluchloralin, flufenacet, flumiclorac-pentyl, flumioxazin, fluorochloridone, flupoxam, flurenol, fluridone, flurtamone, fluthiacet-methyl, indanofan, isoxaben, isoxaflutole, lenacil, linuron, mefenacet, mesotrione, metamitron, metazachlor, methabenzthiazuron, methyldymron, metobenzuron, metolachlor, metosulam, metoxuron, metribuzin, molinate, naproanilide, napropamide, neburon, norflurazon, orbencarb, oryzalin, oxadiargyl, oxadiazon, oxyfluorfen, pebulate, pendimethalin, pentanochlor, pethoxamid, pentoxazone, phenmedipham, pinoxaden, piperophos, pretilachlor, prodiamine, profluazol, prometon, prometryn, propachlor, propanil, propazine, propham, propisochlor, propyzamide, prosulfocarb, pydiflumetofen, pyraflufen-ethyl, pyrazogyl, pyrazolynate, pyrazoxyfen, pyributicarb, pyridate, pyriminobac-methyl, quinclorac, siduron, simazine, simetryn, S-metolachlor, sulcotrione, sulfentrazone, tebutam, tebuthiuron, terbacil, terbumeton, terbuthylazine, terbutryn, thenylchlor, thiazopyr, thidiazimin, thiobencarb, tiocarbazil, triallate, trietazine, trifluralin, and vernolate; herbicide safeners such as benoxacor, dichlormid, fenchlorazole-ethyl, fenclorim, flurazole, fluxofenim, furilazole, isoxadifen-ethyl, mefenpyr; alkali metal, alkaline earth metal, sulfonium or ammonium cation of mefenpyr; mefenpyr-diethyl and oxabetrinil; insecticides such as abamectin, clothianidin, cyantraniliprole, cyanthraniliprole, emamectin benzoate, gamma cyhalothrin, imidacloprid, cyhalothrin and its enantiomers such as lambda cyhalothrin, tefluthrin, permethrin, resmethrin and thiamethoxam; nematicides such as fosthiazate, fenamiphos and aldicarb.

In one embodiment, any active ingredients in the second phase may be in the state of a solution or suspension of a particle. In addition to any active ingredients contained in the first phase can be in the form of a solution or suspended particles.

Further aspects of the invention include a method of preventing or combating infestation of plant species by pests, and regulating plant growth by diluting an amount of concentrate composition with a suitable liquid carrier, such as water or liquid fertilizer, and applying to the plant, tree, animal or locus as desired. The formulations of the present invention may also be combined in a continuous flow apparatus with water in spray application equipment, such that no holding tank is required for the diluted product.

The present compositions can be stored conveniently in a container from which they are poured, or pumped, or into which a liquid carrier is added prior to application.

As used herein, the term “agrochemically effective amount” means the amount of an agrochemical active compound which adversely controls or modifies target pests or regulates the growth of plants (PGR). For example, in the case of herbicides, a “herbicidally effective amount” is that amount of herbicide sufficient for controlling or modifying plant growth. Controlling or modifying effects include all deviation from natural development, for example, killing, retardation, leaf burn, albinism, dwarfing and the like. The term plants refers to all physical parts of a plant, including seeds, seedlings, saplings, roots, tubers, stems, stalks, foliage and fruits. In the case of fungicides, the term “fungicide” shall mean a material that kills or materially inhibits the growth, proliferation, division, reproduction, or spread of fungi. As used herein, the term “fungicidally effective amount” or “amount effective to control or reduce fungi” in relation to the fungicidal compound is that amount that will kill or materially inhibit the growth, proliferation, division, reproduction, or spread of a significant number of fungi. As used herein, the terms “insecticide”, “nematicide” or “acaricide” shall mean a material that kills or materially inhibits the growth, proliferation, reproduction, or spread of insects, nematodes or acarids, respectively. An “effective amount” of the insecticide, nematicide or acaricide is that amount that will kill or materially inhibit the growth, proliferation, reproduction or spread of a significant number of insects, nematodes or acarids.

In one aspect, as used herein, “regulating (plant) growth”, “plant growth regulator”, PGR, “regulating” or “regulation” includes the following plant responses; inhibition of cell elongation, for example reduction in stem height and internodal distance, strengthening of the stem wall, thus increasing the resistance to lodging; compact growth in ornamentals for the economic production of improved quality plants; promotion of better fruiting; increasing the number of ovaries with a view to stepping up yield; promotion of senescence of the formation of tissue enabling fruit to absciss; defoliation of nursery and ornamental bushes and trees for mail-order business in the fall; defoliation of trees to interrupt parasitic chains of infection; hastening of ripening, with a view to programming the harvest by reducing the harvest to one to two pickings and interrupting the food-chain for injurious insects.

In another aspect, “regulating (plant) growth”, “plant growth regulator”, “PGR”, “regulating” or “regulation” also includes the use of a composition as defined according to the present invention for increasing the yield and/or improving the vigor of an agricultural plant. According to one embodiment of the present invention, the inventive compositions are used for improved tolerance against stress factors such as fungi, bacteria, viruses and/or insects and stress factors such as heat stress, nutrient stress, cold stress, drought stress, UV stress and/or salt stress of an agricultural plant.

The selection of application rates relative to providing a desired level of pesticidal activity for a composition of the invention is routine for one of ordinary skill in the art. Application rates will depend on factors such as level of pest pressure, plant conditions, weather and growing conditions as well as the activity of the agrochemically active ingredients and any applicable label rate restrictions.

The term plants refers to all physical parts of a plant, including seeds, seedlings, saplings, roots, tubers, stems, flowers, stalks, foliage and fruits. The term locus refers to where the plant is growing or is expected to grow.

The composition according to the invention is suitable for all methods of application conventionally used in agriculture, e.g. pre-emergence application, post-emergence application, post-harvest and seed dressing. The compositions according to the invention are suitable for pre- or post-emergence applications to crop areas.

The compositions according to the invention are also suitable for combating and/or preventing pests in crops of useful plants or for regulating the growth of such plants. In some embodiments, the compositions may be applied by any method that is conventionally used, including spraying, dripping, and wicking.

Preferred crops of useful plants include canola, cereals such as maize, barley, oats, rye and wheat, cotton, soya, sugar beets, fruits, berries, nuts, vegetables, flowers, trees, shrubs and turf. The components used in the composition of the invention can be applied in a variety of ways known to those skilled in the art, at various concentrations. The rate at which the compositions are applied will depend upon the particular type of pests to be controlled, the degree of control required, and the timing and method of application.

Crops are to be understood as also including those crops which have been rendered tolerant to herbicides or classes of herbicides (e.g. ALS-, GS-, EPSPS-, PPO-, ACCase and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour).

Other useful plants include turf grass for example in golf-courses, lawns, parks and roadsides, or grown commercially for sod, and ornamental plants such as flowers or bushes.

Crop areas are areas of land on which the cultivated plants are already growing or in which the seeds of those cultivated plants have been sown, and also areas of land on which it is intended to grow those cultivated plants.

Other active ingredients such as herbicide, plant growth regulator, algaecide, fungicide, bactericide, viricide, insecticide, acaricide, nematicide or molluscicide may be present in the formulations of the present invention or may be added as a tank-mix partner with the formulations.

The compositions of the invention may further comprise other inert additives. Such additives include thickeners, flow enhancers, dispersants, emulsifiers, wetting agents, antifoaming agents, biocides, lubricants, fillers, drift control agents, deposition enhancers, adjuvants, evaporation retardants, freeze protecting agents, insect attracting odor agents, UV protecting agents, fragrances, and the like. The thickener may be a compound that is soluble or able to swell in water, such as, for example, polysaccharides of xanthans (e.g., anionic heteropolysaccharides such as RHODOPOL® 23 (Xanthan Gum)(Rhodia, Cranbury, NJ)), alginates, guars or celluloses; synthetic macromolecules, such as modified cellulose-based polymers, polycarboxylates, bentonites, montmorillonites, hectonites, or attapulgites. The freeze protecting agent may be, for example, ethylene glycol, propylene glycol, glycerol, diethylene glycol, saccharose, water-soluble salts such as sodium chloride, sorbitol, triethylene glycol, tetraethylene glycol, urea, or mixtures thereof. Representative anti-foam agents are silicone oils, polydialkylsiloxanes, in particular polydimethylsiloxanes, fluoroaliphatic esters or perfluoroalkylphosphonic/perfluoroalkylphosphonic acids or the salts thereof and mixtures thereof. Suitable antifoams are polydimethylsiloxanes, such as Dow Corning® Antifoam A, Antifoam B or Antifoam MSA. Representative biocides include 1,2-benzisothiazolin-3-one, available as PROXEL® GXL (Arch Chemicals).

Examples of surfactants that may be used include linear and branched alcohol ethoxylates and their acid esters, tristyryl-phenol ethoxylates and their acid esters, alkyl-phenol ethoxylates and their acid esters, linear or branched alkyl-aryl sulfonates such as dodecyl-benzene sulfonate, fatty acid ethoxylates, alkyl amine ethoxylates, block copolymers of ethylene oxide and higher alkylene (propylene-, butylene-) oxides. Examples of non-micellar polymeric dispersants include polyvinylpyrrolidone homopolymer with a molecular weight between 15-120 kDa, polyvinylpyrrolidone-vinyl acetate random copolymer, lignosulfonates, sulfonated urea-formaldehyde condensates, styrene acrylic copolymers, comb polymers with an alkyl backbone and side chains of polyacrylic acid, alkylated polyvinylpyrrolidone, and other general, non-emulsifying dispersants.

Dispersants are well known in the art and selection of such will have various factors dependent on a given formulation. Preferred dispersants, as noted above, include, without limitation, polyvinylpyrrolidone homopolymer with a molecular weight between 15-120 kDa, polyvinylpyrrolidone-vinyl acetate random copolymer, lignosulfonates, sulfonated urea-formaldehyde condensates, styrene acrylic copolymers, comb polymers with alkyl backbone and side chains of polyacrylic acid, alkylated polyvinylpyrrolidone, and other general, non-emulsifying dispersants.

The compositions of the invention may be mixed with fertilizers and still maintain their stability.

The compositions of the invention may be used in conventional agricultural methods. For example, the compositions of the invention may be mixed with water and/or fertilizers and may be applied preemergence and/or postemergence to a desired locus by any means, such as airplane spray tanks, irrigation equipment, direct injection spray equipment, knapsack spray tanks, cattle dipping vats, farm equipment used in ground spraying (e.g., boom sprayers, hand sprayers), and the like. The desired locus may be soil, plants, and the like.

The present technology further includes a method for treating seeds or plant propagules, comprising contacting said seeds or plant propagules with a composition of the present invention. The present technology can be applied to a seed or plant propagule in any physiological state, at any time between harvest of the seed and sowing of the seed; during or after sowing; and/or after sprouting. It is preferred that the seed or plant propagule be in a sufficiently durable state that it incurs no or minimal damage, including physical damage or biological damage, during the treatment process. A formulation may be applied to the seeds or plant propagules using conventional coating or pelleting techniques and machines, such as: fluidized bed techniques, the roller mill method, rotostatic seed treaters, and drum coaters. The seeds or plant propagules may be pre-sized before coating. After coating, the seeds or plant propagules are typically dried and then transferred to a sizing machine for sizing. Such procedures are known in the art. In some embodiments, a composition of the present invention is applied as one ingredient of a seed or plant propagule coating. The treated seeds may also be enveloped with a film over-coating to protect the coating. Such over-coatings are known in the art and may be applied using conventional fluidized bed and drum film coating techniques, for example.

Certain embodiments of the invention are directed to processes for making a composition. Embodiments of methods of making include preparing a first phase, preparing a second phase, dissolving or suspending an agrochemical active ingredient into the second phase, incorporating cellulose nanocrystals in one or both of the first phase or the second phase, combining the first phase and the second phase to form a composition, agitating the composition to form an emulsion; and cross-linking the cellulose nanocrystals to form a matrix shell around droplets of the second phase.

### Various Embodiments

Embodiment 1. A liquid composition, comprising:
a first phase;
a second phase which is immiscible and dispersed in the first phase;
a matrix of cross-linked cellulose nanocrystals at the interface between the first phase and the second phase; and
at least one agrochemically active ingredient in the second phase.

Embodiment 2. The composition of Embodiment 1, further comprising a dispersant.

Embodiment 3. The composition of Embodiment 1, wherein the composition is free of an emulsifying surfactant.

Embodiment 4. The composition of Embodiment 1, wherein the cross-linked cellulose nanocrystals are cross-linked with glutaraldehyde.

Embodiment 5. The composition of Embodiment 1, wherein the cross-linked cellulose nanocrystals cover 40-80% of the interface between the first phase and the second phase.

Embodiment 6. The composition of Embodiment 1, wherein the first phase contains cellulose nanocrystals sufficient to alter the viscosity of the composition by more than 10% as compared to the composition without the cellulose nanocrystals in the first phase.

Embodiment 7. The composition of Embodiment 1, wherein the cross-linked cellulose nanocrystals are cross-linked with citric acid.

Embodiment 8. The composition of Embodiment 1, wherein the cross-linked cellulose nanocrystals are cross-linked with tannic acid.

Embodiment 9. The composition of Embodiment 1, wherein the first phase comprises water, one or more substantially water-miscible, non-aqueous liquids, or a mixture of water and one or more water-miscible liquids.

Embodiment 10. The composition of Embodiment 9, wherein the substantially water-miscible, non-aqueous liquid is selected from propylene carbonate, ethylene glycol, diethylene glycol, triethylene glycol, propylene glycol, dipropylene glycol, tripropylene glycol, butylene glycol, hexylene glycol, polyethylene glycols having a molecular weight of up to about 800, di(propylene glycol), diacetin, triacetin, methyl ether acetate, propylene glycol diacetate, triethyl phosphate; ethyl lactate, gamma-butyrolactone, propanol, tetrahydrofurfuryl alcohol, N-methyl pyrrolidone, dimethyl lactamide, and mixtures thereof.

Embodiment 11. The composition of Embodiment 1, wherein the first phase comprises water and a water-soluble solute.

Embodiment 12. The composition of Embodiment 11, wherein the water-soluble solute is selected from an acid, a base, a salt, a sugar, a polysaccharide, a protein, an amino acid, betaine and mixtures thereof.

Embodiment 13. The composition of Embodiment 1, wherein the first phase further comprises at least one agrochemically active ingredient and the active ingredient is in the state selected from a solution or a suspension of particles.

Embodiment 14. The composition of Embodiment 1, wherein the cross-linked cellulose nanocrystals are cross-linked with boric acid.

Embodiment 15. The composition of Embodiment 1, wherein the cross-linked cellulose nanocrystals are 0.1-5% w/w of the composition.

Embodiment 16. The composition of Embodiment 1, wherein the cross-linked cellulose nanocrystals are about 1-2% w/w of the composition.

Embodiment 17. The composition of Embodiment 1, wherein the cross-linked cellulose nanocrystals are about 3-5% w/w of the composition.

Embodiment 18. The composition of Embodiment 1, wherein the cross-linked cellulose nanocrystals have an aspect ratio of 1:1 to 1:100.

Embodiment 19. The composition of Embodiment 1, wherein the cross-linked cellulose nanocrystals have an aspect ratio of about 1:50.

Embodiment 20. The composition of Embodiment 1, wherein the cross-linked cellulose nanocrystals have a width of about 1-100 nm and length of about 100-1000 nm.

Embodiment 21. The composition of Embodiment 1, wherein the cross-linked cellulose nanocrystals have a multi-modal distribution.

Embodiment 22. The composition of Embodiment 1, wherein the cross-linked cellulose nanocrystals are obtained from microbes.

Embodiment 23. The composition of Embodiment 1, wherein the cross-linked cellulose nanocrystals are obtained from plant matter.

Embodiment 24. The composition of Embodiment 1, wherein the second phase comprises droplets with median diameter between 1 and 100 microns.

Embodiment 25. The composition of Embodiment 24, wherein the second phase comprises droplets with a median diameter of between 1 and 50 microns.

Embodiment 26. The composition of Embodiment 25, wherein the second phase comprises droplets with a median diameter of between 1 and 10 microns.

Embodiment 27. A method of combating infestation of plant species by pests, or regulating plant growth by diluting an effective amount of concentrated composition according to Embodiment 1 with an aqueous liquid carrier selected from water and liquid fertilizer, or a combination thereof, and applying the dilute composition to the plant species or locus thereof.

Embodiment 28. A method, comprising:
preparing a first phase;
preparing a second phase;
dissolving or suspending an agrochemical active ingredient into the second phase;
incorporating cellulose nanocrystals in one or both of the first phase or the second phase;
combining the first phase and the second phase to form a composition;
agitating the composition to form an emulsion; and
cross-linking the cellulose nanocrystals to form a matrix shell around droplets of the second phase.

Embodiment 29. The method according to Embodiment 28, wherein the cross-linking is with glutaraldehyde.

Embodiment 30. The method according to Embodiment 29, wherein the cross-linking is with citric acid.

Embodiment 31. The method according to Embodiment 28, wherein the cross-linking is with tannic acid.

Embodiment 32. The method according to Embodiment 28, wherein the cross-linking is with boric acid.

Embodiment 33. The method according to Embodiment 28, further comprising agitating the first phase and/or the second phase after the incorporating but before the combining.

Embodiment 34. The method according to Embodiment 28, further comprising incorporating a salt into the first phase and/or the second phase.

Embodiment 35. The method according to Embodiment 28, wherein the second phase comprises droplets with median diameter between 1 and 100 microns

Embodiment 36. An article of manufacture comprising:
a plant seed coated with the composition of Embodiment 1.

Embodiment 37. The article of claim 36, wherein the composition is dried.

Embodiment 38. The composition of Embodiment 1, wherein the at least one agrochemically active ingredient has a slow maximum payload release through the matrix of cross-linked cellulose nanocrystals.

Embodiment 39. The composition of Embodiment 1, wherein the at least one agrochemically active ingredient has a fast maximum payload release through the matrix of cross-linked cellulose nanocrystals.

### EXAMPLES

The following examples illustrate further some of the aspects of the invention but are not intended to limit its scope. Where not otherwise specified throughout this specification and claims, percentages are by weight.

### Example 1: Preparation of CNC Formulation

| | Mass (g) | Composition (wt %) |
|---|---|---|
| Phase 1 | | |
| Water | Q.S. | Q.S. |
| NaCl | 0.06 | 0.03% |
| CNC spray dried powder | 2.80 | 1.40% |
| Phase 2 | | |
| Aromatic 200 | 40.00 | 20% |
| Lambda-cyhalothrin | 40.00 | 20% |
| Total | 200 | 100.00% |

A composition accordingly to the above table was prepared as follows: NaCl was dissolved in water and then the required amount of CNC solids were added and homogenized using high shear mixing until any CNC particles or CNC aggregates are discrete from one another and smaller than 20 μm. Lambda-cyhalothrin was solubilized in the oil phase solvent and then added to the water and CNC composition. The resulting composition was homogenized using high shear mixing (Turrax 15k RPM for 2×3 min) to obtain an emulsion droplet size of 1-10 μm.

### Example 2: Preparation of Crosslinked Formulations

| | Mass (g) | Composition (wt %) |
|---|---|---|
| Phase 1 | | |
| Water | Q.S. | Q.S. |
| NaCl | 0.06 | 0.03% |
| CNC spray dried powder | 2.80 | 1.40% |
| Phase 2 | | |
| Aromatic 200 | 40.00 | 20% |
| Lambda-cyhalothrin | 40.00 | 20% |
| Post addition crosslinker | | |
| crosslinker | 1.00-4.00 | 0.50-2.00% |
| Total | 200 | 100.00% |

A formulation was prepared in the same way as described in Example 1. Once the target droplet size was achieved, the crosslinker: citric acid (2 wt %), tannic acid (0.5 wt %), or glutaraldehyde (4 wt % of a 25% aqueous solution) was slowly added with gentle stirring. Upon complete addition, the formulation was heated to 60° C. for 4 hours then left to cool to room temperature.

### Example 3: Storage

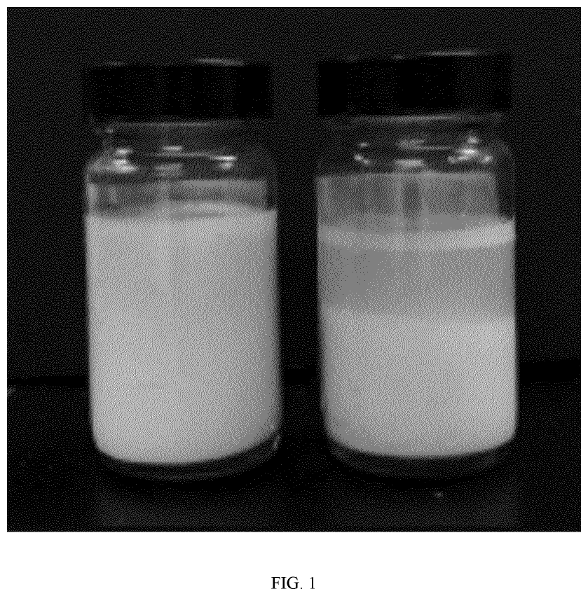

An accelerated storage study was conducted on the CNC formulation with and without glutaraldehyde crosslinker. Testing showed clear improvements after storage at high temperatures and temperature cycling. No separation was noted for the crosslinked sample whereas failure occurred for the non-crosslinked sample under the temperature cycling regime. Additionally, the pH and viscosity profiles show far less variation from the initial measurements in the crosslinked sample whereas a decrease of 2 pH units is noted along with severe thickening without crosslinker. A comparison of the formulations: (A) with 2% glutaraldehyde and (B) without glutaraldehyde are shown in FIG. 1 after 2 weeks of cycling temperature between −10 to 50° C. every 20 h. The results are provided in the below table:

| | | | | | | Particle size | | |
|---|---|---|---|---|---|---|---|---|
| | | Pour | | | Viscosity | D[4, 3] | Dv50 | Dv95 |
| Crosslinker | Condition | out | Probe | pH | (cP) | (μm) | (μm) | (μm) |
| No crosslinker | initial | | | 6.34 | 340 | 3.79 | 3.53 | 8.54 |
| No crosslinker | 4 weeks 50 c | pass | pass | 4.60 | 720 | 6.44 | 6.36 | 12.5 |
| No crosslinker | 2 weeks cycling | fail | fail | fail | fail | fail | fail | fail |
| Glutaraldehyde | initial | | | 3.40 | 497 | 4.61 | 4.06 | 11.2 |
| Glutaraldehyde | 4 weeks 50 c | pass | pass | 3.34 | 532 | 7.23 | 6.97 | 14.7 |
| Glutaraldehyde | 2 weeks cycling | pass | pass | 3.28 | 592 | 6.77 | 6.41 | 14.3 |

### Example 4: Dry Down

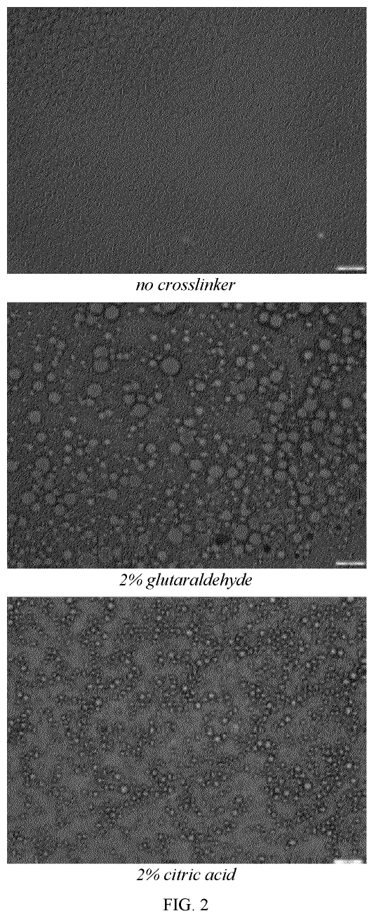

Allowing the crosslinked and non-crosslinked samples to dry on a microscope slide allowed the fine structuring of the emulsion to be observed upon evaporation of the water carrier. In the case with no crosslinker, no fine structure was observed with collapse of the emulsion being evident. When glutaraldehyde or citric acid crosslinkers are included, fine structure can be seen in detail via microscopy showing an increase in the mechanical strength of the CNC matrix at the interface. The microscopy images are provided in FIG. 2.

### Example 5: Release Rate Experiments

| | Mass (g) | Composition (wt %) |
|---|---|---|
| Phase 1 | | |
| Water | Q.S. | Q.S. |
| NaCl | 0.015 | 0.03% |
| CNC spray dried powder | 1.00 | 2.00% |
| Phase 2 | | |
| Aromatic 200 | 4.50 | 9.00% |
| Dimethylphthalate | 0.50 | 1.00% |
| Post addition crosslinker | | |
| Crosslinker (or make up water) | 2.5 | 5.00% |
| Total | 50 | 100.00% |

A formulation was prepared in the same way as described in Example 1 using the amounts indicated in the above table. Dimethylphthalate (DMIP) was loaded into second phase. The composition was divided into three equal amounts with one batch remaining without crosslinker (water was added to total 100% in place of crosslinker in other samples to keep loadings consistent), citric acid crosslinker was added to the second batch, and glutaraldehyde crosslinker was added to the third batch, with all batches being cured at 50° C. for 18 hours. Separately, each sample was subjected to the following protocol to assess the diffusion of the UV active DMP across the interfacial matrix layer.
1) a 30 cm long piece of dialysis tubing was prepared by soaking in deionized water for 18 hours.
2) The bottom end of the dialysis tubing was sealed by tying a knot.
3) 1 ml of the formulation was injected into to the center of the dialysis tubing with the top then being tied off.
4) The tubing was put in 100 ml of deionised water in a 150 ml glass bottle, shaken, and take 3 ml for an initial sample.
5) The glass bottle containing dialysis tubing was put on a roller.
6) The UV spectrum of the 3 ml sample on the UV spectrophotometer was collected across the range of 250-300 nm as DMP absorbs at 275 nm.
7) The absorbance at 275n, was recorded.
8) The sample was returned to the glass bottle containing the dialysis tubing.
9) The process was repeated at 30 mins, 1 hour, 2 hour or until a plateau was reached.

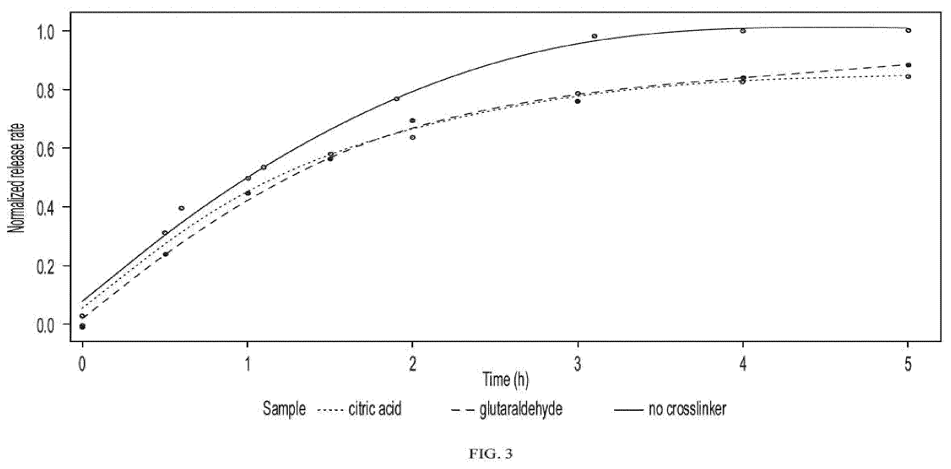

The results of these studies are shown in FIG. 3. The release rate study showed that the utilization of a crosslinker depresses the release rate of DMP across the interfacial matrix as compared to when no crosslinker is used. That is, a larger quantity of DMP is released at a faster rate in the absence of a crosslinker.

### Example 6: Release Rate Experiments

| | Batch | | | | | |
|---|---|---|---|---|---|---|
| Component (w/w %) | A | B | C | D | E | F |
| Phase 1 | | | | | | |
| Water | Q.S. | Q.S. | Q.S. | Q.S. | Q.S. | Q.S. |
| NaCl | 0.03 | 0.03 | 0.03 | 0.03 | 0.03 | 0.03 |
| CNC spray dried powder | 1.4 | 1.4 | 1.4 | 1.4 | 1.4 | 1.4 |
| Phase 2 | | | | | | |
| Aromatic 200 | 20 | 20 | 20 | 20 | 20 | 20 |
| Lambda-cyhalothrin | 20 | 20 | 20 | 20 | 20 | 20 |
| Post addition crosslinker | | | | | | |
| Citric acid | 0 | 4 | 2 | 0 | 0 | 0 |
| Tannic acid | 0 | 0 | 0 | 2 | 0.14 | 0 |
| Glutaraldehyde | 0 | 0 | 0 | 0 | 0 | 1 |
| Total | 100 | 100 | 100 | 100 | 100 | 100 |

A formulation was prepared in the same way as described in Example 1 using the amounts indicated in the above table. The composition was divided into six equal amounts with Batch A remaining without crosslinker. Citric acid crosslinker was added to Batch B and C with loadings of 4 w/w % and 2 w/w % respectively. Tannic acid was added to Batch D and E with loadings of 2 w/w % and 0.14 w/w % respectively. Glutaraldehyde was added to Batch F as a 25% aqueous solution (1 w/w % glutaraldehyde content, 4% Aq solution content). All batches were cured at 50° C. for 18 hours. Separately, each sample was subjected to the following protocol which is a slightly modified version of the Collaborative International Pesticides Analytical Council (CIPAC) method ‘MT 190—Determination of release properties of lambda-cyhalothrin cs formulations’ to assess the diffusion of the agriculturally active ingredient across the interfacial matrix layer. The modification to this method omits the use of ethanol from the internal standard solution.
1. An internal standard (IS) solution was prepared comprising dicyclohexylphthalate (350 mg) dissolved in hexane (1 L).
2. Approximately 500 mg of formulation was diluted in deionized water up to 6 mL noting the exact mass of formulation used.
3. 100 mL of IS solution was added to the diluted formulation prepared in step 2.
4. This was gently swirled and a 1 mL aliquot of the hexane layer was removed and placed into a GC vial with 1 drop of trifluoroacetic acid being added. The vial was then capped and sealed.
5. The sample was then placed on a horizontal roller, not end-over-end, and set to roll at 70 rpm.
6. Further 1 mL aliquots were removed from the hexane fraction and placed in a GC vial at the desired timepoints such as 5, 10, 15, 30, 60, 90, 180, 360 and 1440 minutes with 1 drop of trifluoroacetic acid being added before being sealed. The sample was placed back on the roller after each aliquot removal.
7. The lambda-cyhalothrin content was then measured via GC using the procedure outlined in CIPAC method MT190.

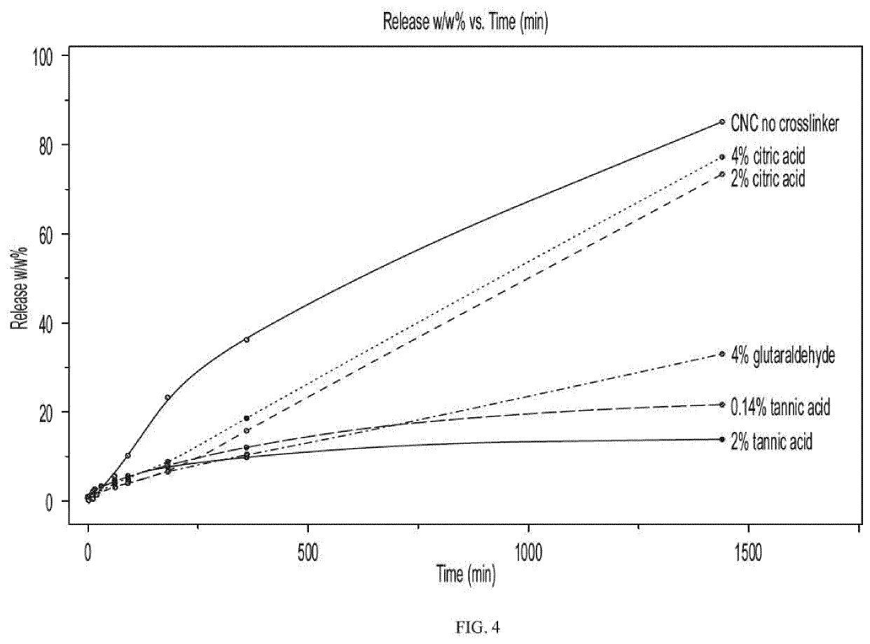

The results of these studies are shown in FIG. 4. The release rate study showed that the utilization of a crosslinker depresses the release rate of lambda-cyhalothrin across the interfacial matrix depending on the type and amount of crosslinker that is used when compared to no crosslinker. When no crosslinker is used, a pseudo-inverse exponent release is observed with an initial burst release profile which then tapers off over time. The use of citric acid gives a steady-state relatively fast linear release of lambda-cyhalothrin whereas glutaraldehyde and tannic acid give a much more tempered release rate with increasing amounts of tannic acid giving slower release rates.

### Example 7: Release Rate Experiments

| | Batch | | | |
|---|---|---|---|---|
| Component (w/w %) | A | B | C | D |
| Phase 1 | | | | |
| Water | Q.S. | Q.S. | Q.S. | Q.S. |
| NaCl | 0.03 | 0.03 | 0.03 | 0.03 |
| CNC spray dried powder | 1.4 | 1.4 | 1.4 | 1.4 |
| Phase 2 | | | | |
| Aromatic 200 | 20 | 20 | 20 | 20 |
| Lambda-cyhalothrin | 20 | 20 | 20 | 20 |
| Post addition crosslinker | | | | |
| Citric acid | 0 | 2 | 0 | 0 |
| Tannic acid | 0 | 0 | 2 | 0 |
| Glutaraldehyde | 0 | 0 | 0 | 1 |
| Total | 100 | 100 | 100 | 100 |

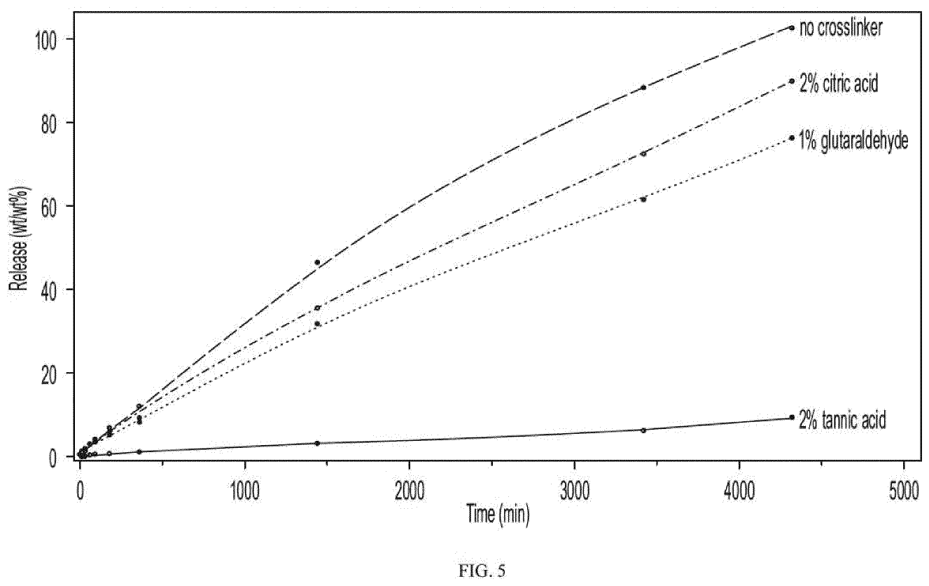

A formulation was prepared in the same way as described in Example 1 using the amounts indicated in the above table. The release rates of these compositions were tested using the methodology of Example 6. The results are provided in FIG. 5 which follows a similar trend to that seen in Example 6 whereby different crosslinkers attenuate the release of lambda-cyhalothrin across the interfacial matrix. Tannic acid provides the highest barrier to release followed by glutaraldehyde, then citric acid which provides the weakest barrier to release of the crosslinkers. As a control, no crosslinker displays the fastest release rate exemplifying the effect the crosslinkers have on lambda-cyhalothrin diffusion.

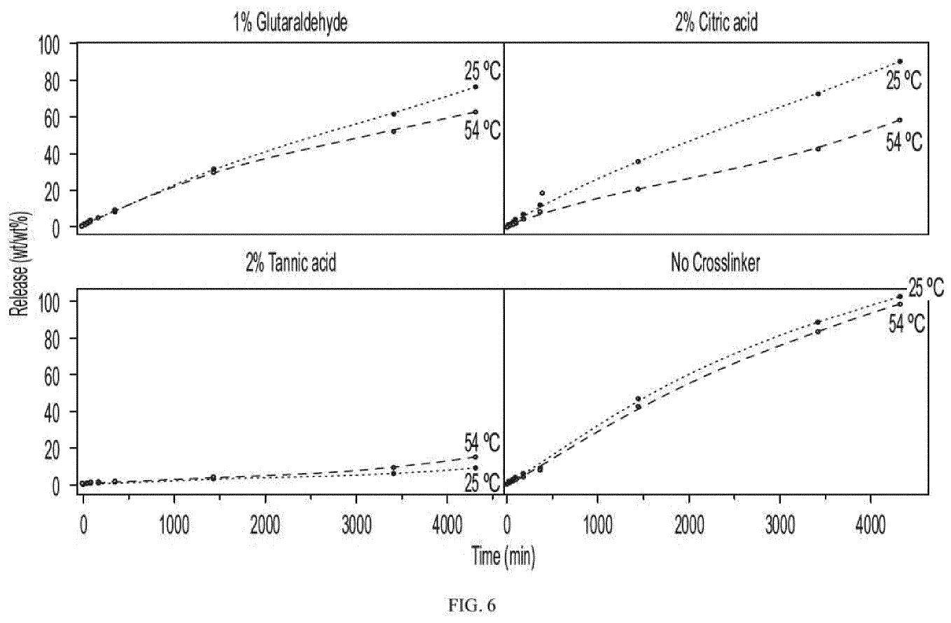

After initial testing, the formulations were stored for two weeks at either 25° C. or 54° C. Release rates were again tested. The results are provided in FIG. 6. Generally, these crosslinked systems show little change, or slight improvements, to their release rate profiles and diffusion kinetics post-storage which demonstrates their long-term physical stability as slow or fast release system.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A liquid composition, comprising:
a first phase;
a second phase which is immiscible and dispersed in the first phase;
a matrix of cross-linked cellulose nanocrystals at the interface between the first phase and the second phase; and
at least one agrochemically active ingredient in the second phase.

2. The composition of claim 1, wherein the cross-linked cellulose nanocrystals are cross-linked with glutaraldehyde.

3. The composition of claim 1, wherein the cross-linked cellulose nanocrystals cover 40-80% of the interface between the first phase and the second phase.

4. The composition of claim 1, wherein the first phase contains cellulose nanocrystals sufficient to alter the viscosity of the composition by more than 10% as compared to the composition without the cellulose nanocrystals in the first phase.

5. The composition of claim 1, wherein the cross-linked cellulose nanocrystals are cross-linked with citric acid.

6. The composition of claim 1, wherein the cross-linked cellulose nanocrystals are cross-linked with tannic acid.

7. The composition of claim 1, wherein the cross-linked cellulose nanocrystals are cross-linked with boric acid.

8. The composition of claim 1, wherein the cross-linked cellulose nanocrystals are 0.1-5% w/w of the composition.

9. The composition of claim 1, wherein the cross-linked cellulose nanocrystals have a multi-modal distribution.

10. The composition of claim 1, wherein the second phase comprises droplets with a median diameter of between 1 and 10 microns.

11. The composition of claim 1, wherein the at least one agrochemically active ingredient has a slow maximum payload release through the matrix of cross-linked cellulose nanocrystals.

12. The composition of claim 1, wherein the at least one agrochemically active ingredient has a fast maximum payload release through the matrix of cross-linked cellulose nanocrystals.

13. A method of combating infestation of plant species by pests, or regulating plant growth by diluting an effective amount of concentrated composition according to claim 1 with an aqueous liquid carrier selected from water and liquid fertilizer, or a combination thereof, and applying the dilute composition to the plant species or locus thereof.

14. A method, comprising:
dissolving or suspending an agrochemical active ingredient into a first phase;
incorporating cellulose nanocrystals in one or both of the first phase or a second phase;
combining the first phase and the second phase to form a composition;
agitating the composition to form an emulsion; and
cross-linking the cellulose nanocrystals to form a matrix shell around droplets of the second phase.

15. The method according to claim 14, further comprising incorporating a salt into the first phase and/or the second phase.

16. An article of manufacture comprising:
a plant seed coated with the composition of claim 1.

17. The article of claim 16, wherein the composition is dried.
